(19) United States
(12) Patent Application Publication
(10) Pub. No.: US 2010/0272991 A1
(43) Pub. Date: Oct. 28, 2010

(54) CHROME-FREE COATING COMPOSITIONS FOR SURFACE-TREATING STEEL SHEET INCLUDING CARBON NANOTUBE, METHODS FOR SURFACE-TREATING STEEL SHEET AND SURFACE-TREATED STEEL SHEETS USING THE SAME

(75) Inventors: Young-Jun Park, Pohang (KR); Gab-Yong Kim, Incheon (KR); Hoon Cheong, Suwon (KR)

Correspondence Address: THE WEBB LAW FIRM, P.C., 700 KOPPERS BUILDING, 436 SEVENTH AVENUE, PITTSBURGH, PA, 15219, US

(73) Assignee: POSCO, Pohang (KR)

(21) Appl. No.: 12/810,340

(22) PCT Filed: Dec. 23, 2008
(86) PCT No.: PCT/KR08/07625

§ 371 Date: Jun. 24, 2010

(30) Foreign Application Priority Data
Dec. 27, 2007 (KR) 10-2007-0139378
May 8, 2008 (KR) 10-2008-0042789
May 22, 2008 (KR) 10-2008-0047449
May 22, 2008 (KR) 10-2008-0047450

(51) Int. Cl. B32B 15/08; H01B 1/24

(52) U.S. Cl. 428/341; 252/506; 252/503; 977/742

(57) ABSTRACT

A chrome-free coating composition for surface-treating a hot-dip galvanized steel sheet that includes carbon nanotubes and has excellent electric conductivity, comprising, based on the total solid weight of the composition: (a) 40 to 60 parts by weight of a water-soluble or water-borne organic resin; (b) 20 to 40 parts by weight of an inorganic metallic sol; (c) 2 to 5 parts by weight of a carbon nanotube paste including carbon nanotube (CNT); (d) 2 to 5 parts by weight of a metal oxide/phosphate-based anti-corrosion agent; (e) 5 to 15 parts by weight of an organic metal complex; (f) 3 to 7 parts by weight of a carbodimide cross-linking agent; and (g) the balance of water, ethanol or a mixture thereof. The steel sheet surface-treated with the composition may be useful to secure corrosion resistance without including a chrome component and shows its electric conductivity even when the coating composition is used at a coating amount of 1000 mg/m² or more.

### TECHNICAL FIELD

The present invention relates to a chrome-free coating composition for surface-treating a steel sheet including a carbon nanotube paste in which carbon nanotube is distributed, and a surface-treated steel sheet using the same, and more particularly, to a coating composition for surface-treating a steel sheet capable of securing corrosion resistance without including a chrome component and showing its electric conductivity even when the coating composition is used at a coating amount of 1000 mg/m² or more, and a surface-treated steel sheet using the same.

### BACKGROUND ART

When a coating layer, which is composed of zinc, nickel, aluminum, silica or combinations thereof, is formed in a steel sheet, the steel sheet has very excellent corrosion resistance and high-quality appearance, compared to the conventional cold and hot-rolled steel sheets. However, the galvanized steel sheet and various coated steel sheets may be contaminated with user's fingerprints due to the rough zinc particles, and also be apt to corrode easily (white rust, etc.) when metal components such as zinc are exposed to the corrosion environment for an extended time period.

Therefore, it has been known that when the galvanized steel sheets are exposed to the corrosion environment, they are surface-treated with phosphates, chromates and the like in order to prevent formation of white rust and improve workability and fingerprint resistance. Among them, the pretreatment with chromates has been most widely used in the industrial world. This is why the steel sheet has the most excellent corrosion resistance and the treatment is inexpensive and economical with money since the potent autooxidation of hexavalent chromium prevents the oxidation of iron and zinc.

However, the environmental regulations have been recently reinforced all over the world, and, in particular, hexavalent chromium included in a chromate-treating solution may cause workers to catch lung cancer due to its potent oxidation power, and may cause severe water pollution by the discharge of waste water generated during the disposal of the chromate-treating solution. Also, commercial articles, such as automobiles, home electronic appliance sand construction materials, which are made from the steel sheet coated with the chromate-treating solution, has problems associated with their recycling and disposal. In addition, the use of hexavalent chromium in the steel sheet for automobiles has been strictly regulated in Europe since 2003, and there is also an increasing demand for chrome-free products using the steel sheet for home electronic appliances and construction materials.

Therefore, there have been argent attempts to develop a surface-treating agent such as a fingerprint/corrosion-resistant metal coating agent that does not include hexavalent chromium while satisfying the requirements associated with the corrosion resistance and conductivity of the steel sheet in many iron-making companies. Also, a chrome-free, low-temperature curable coating composition for surface-treating a steel sheet has been under examination. Here, since the curable coating composition includes a compound such as vanadium and magnesium, which may be used instead of chrome, in addition to the silane compounds or their hydrolysates having an epoxy group and an amino group, it may be cured at a low temperature and secure the corrosion resistance without the use of any chrome component.

Furthermore, polyaniline has been increasingly used as a conductive polymer to secure electric conductivity and corrosion resistance of a steel sheet at a surface resistance of 10⁻³ Ω(ohm)/cm² or less after surface-treating the steel sheet. However, the steel sheet wasted with the conductive polymer has a disadvantage in that a conductive polymer film may be damaged due to its high brittleness when the steel sheet is subject to a bending process. In order to give a smooth appearance to the steel sheet, the steel sheet should have an average surface roughness (Ra) of 1 μm (micrometer) or less, which represents an average value of a steel sheet. Therefore, the actual roughness of the steel sheet may exceed 1 μm, and the steel sheet may not satisfy both of the corrosion resistance and conductivity at the same time when the surface-treated steel sheet is coated with the coating composition according to the surface roughness of the steel sheet. That is to say, when the actual surface roughness of the steel sheet is less than 1 μm, or up to 0.8 μm, a surface of the steel sheet is not exposed by the coated conductive polymer film. Therefore, the steel may have excellent corrosion resistance, but show its very low conductivity. Also, when the actual surface roughness of the steel sheet exceeds 1 μm, the steel may have excellent electric conductivity, but show its poor corrosion resistance since the surface of the steel sheet is exposed to the severe corrosion environment.

Therefore, there is an increasing demand for a coating composition for surface-treating a steel sheet having excellent corrosion resistance and electric conductivity without affecting the surface roughness of the steel sheet.

### DISCLOSURE OF INVENTION

### Technical Problem

The present invention is designed to solve the problems of the prior art, and therefore it is an object of the present invention to provide a coating composition for surface-treating a steel sheet having excellent electric conductivity even when the coating composition is used at a coating amount of 1000 mg/m² or more, the coating composition being able to secure the corrosion resistance while a film coated with a coating composition for surface-treating a steel sheet does not include a chrome component at all regardless of the surface roughness of the steel sheet, a surface-treated steel sheet using the same and a method for manufacturing a surface-treated steel sheet.

### Technical Solution

According to an aspect of the present invention, there is provided a chrome-free coating composition for surface-treating a hot-dip galvanized steel sheet having excellent electric conductivity, the composition including, based on the total solid weight of the composition: (a) 40 to 60 parts by weight of a water-soluble or water-borne organic resin as a base resin; (b) 20 to 40 parts by weight of an inorganic metallic sol; (c) 2 to 5 parts by weight of a carbon nanotube paste including carbon nanotube (CNT); (d) 2 to 5 parts by weight of a metal oxide/phosphate-based anti-corrosion agent; (e) 5 to 15 parts by weight of an organic metal complex; and (f) 3 to 7 parts by weight of a carbodimide crosslinking agent.

In this case, the chrome-free coating composition may further include water or alcohol as a solvent so that the total solid content in the composition can be in a range of 5 to 25% by weight.

Also, the water-soluble or water-borne organic resin may be selected from the group consisting of a water-dispersible urethane resin having a carboxy or hydroxyl group, an acrylic resin having a carboxy or hydroxyl group, an acryl or vinyl-modified water-dispersible urethane resin, an olefin resin such as poly(ethylene-co-acrylic rid) and poly(ethylene-co-methacrylic rid), a phenoxy resin including bisphenol A, and mixtures thereof.

In addition, the inorganic metallic sol may be selected from the group consisting of a silica sol, an alumina sol, a titania sol, a zirconia sol and mixtures thereof.

Additionally, the inorganic metallic sol may have a metal particle size of 5 to 30 nm.

Also, the carbon nanotube paste may be prepared by distributing carbon nanotube in a resin selected from the group consisting of a water-dispersible urethane resin; a copolymer such as poly(p-phenylenevinylene) (PPV), poly(p-phenylenevinylene-co-2,5-dioctoxy-m-phenylenevinylene) (PMPV) and polyaryleneethylene; a water-soluble polymer such as poly(vinylalcohol), poly(ethyleneoxide) and polysaccharide; and a surfactant such as sodium dodecyl sulfate, lithium dodecyl sulfate and cetyltrimethylammonium chloride.

In addition, the corrosion resistance rust inhibitor may be an aqueous solution including one selected from the group consisting of vanadium, zirconium, titanium, molybdenum, tungsten, manganese, cerium and mixtures thereof, or an aqueous phosphate solution of phosphate or hexaammonium heptamolybdate tetrahydrate including one selected from the group consisting of aluminum, aluminum diphosphate, zinc, molybdenum, fluorine and mixtures thereof.

Additionally, the organic metal complex may be selected from the group consisting of a silane-based coupling agent, a titanium-based coupling agent, a zirconium-based coupling agent and mixtures thereof.

Also, the chrome-free coating composition may further include an alkoxy silane compound, wherein an organic/inorganic composite resin is formed by reaction of the water-soluble or water-borne organic resin and inorganic metallic sol and the alkoxy silane compound.

Additionally, the alkoxy silane compound may be present at a content of 1 to 10 parts by weight, based on 100 parts by weight of the sum of the solid weights of the water-soluble or water-borne organic resin and the inorganic metal sol.

Furthermore, the alkoxy silane compound may include epoxysilane such as (3-glycidoxypropyl)trimethoxysilane, 2-(3,4-epoxycyclohexyl)ethyltrimethoxysilane, 3-glycidoxypropylmethyldiethoxysilane and 3-glycidoxypropyltriethoxysilane, or aminosilane such as N-2(aminoethyl)-3-aminopropylmethyldimethoxysilane, 3-aminopropyltrimethoxysilane, 3-aminopropyltriethoxysilane, 3-triethoxysilyl-N-(1,3-dimethyl-butylidene)propyl amine, N-phenyl-3-aminopropyltrimethoxysilane and N-(vinylbenzyl)-2-aminoethyl-3-aminopropyltrimethoxysilane hydrochloride.

According to another aspect of the present invention, there is provided a method for surface-treating a steel sheet having excellent electric conductivity, the method including: forming a surface-treated layer on a hot-dip galvanized layer, wherein the surface-treated layer is formed by coating a steel sheet with the coating composition for surface-treating a steel sheet, and drying the coating composition at a peak metal temperature (PMT) of 100 to 130° C. (degrees Celsius).

In this case, a coating amount of the surface-treated layer may be in a range of 600 to 2000 mg/m².

According to still another aspect of the present invention, there is provided a surface-treated steel sheet having excellent electric conductivity, including a hot-dip galvanized layer and a surface-treated layer, wherein the surface-treated layer is formed from the coating composition for surface-treating a steel sheet defined in any one claims 1 to 8, and a coating amount of the surface-treated layer is in a range of 600 to 2000 mg/m².

### ADVANTAGEOUS EFFECTS

As described above, the surface-treated steel sheet, which has excellent physical properties even when the coating composition is dried and cured at a low temperature, shows its excellent electric conductivity even when the coating composition is used at a coating amount of 1000 mg/m² or more, and also has excellent corrosion resistance, may be prepared by coating a metal steel sheet with the chrome-free coating composition for surface-treating a steel sheet including carbon nanotube according to one exemplary embodiment of the present invention.

Also, the chrome-free coating composition for surface-treating a steel sheet according to one exemplary embodiment of the present invention does not include a heavy metal that is harmful to human body, and its components are dissolved in water (main component) used as a solvent. Therefore, the chrome-free coating composition according to one exemplary embodiment of the present invention may be useful to relieve an energy-saving problem, environmental pollutions, operational hygienic/stability problems and fire risks.

### BEST MODE FOR CARRYING OUT THE INVENTION

Hereinafter, the exemplary embodiments of the present invention will be described in more detail.

The coating composition for surface-treating a steel sheet according to one exemplary embodiment of the present invention includes a base resin (i.e. a water-soluble or water-borne organic resin); an inorganic metallic sol; a carbon nanotube paste including carbon nanotube (CNT); a metal oxide/phosphate-based, anti-corrosion agent; an organic metal complex; a carbodimide crosslinking agent; and the balance of water, ethanol or a mixture thereof.

The water-soluble or water-borne organic resin used as the base resin in the present invention may include a water-dispersible urethane resin having a carboxy or hydroxyl group, an acrylic resin having a carboxy or hydroxyl group, and an acryl or vinyl-modified water-dispersible urethane resin. Also, olefin resin such as poly(ethylene-co-acrylic rid) or poly(ethylene-co-methacrylic acid), and more preferably olefin resin having a weight average molecular weight of 10,000 to 50,000 may be used as the water-soluble or water-borne organic resin. In addition, phenoxy resin including bisphenol A, and preferably phenoxy resin having a weight average molecular weight of 20,000 to 100,000 may be used as the water-soluble or water-borne organic resin. They may be used alone or in combinations thereof.

The base resin may be used at a content of 40 to 60 parts by weight, based on the total solid content of the coating composition for surface-treating a steel sheet according to one exemplary embodiment of the present invention. When the base resin is present at a content of less than 40 parts by weight, the adhesion to a surface of the steel sheet is low, and it is difficult to obtain a uniform film, whereas a film of uniform thickness is coated onto the surface of the steel but the corrosion resistance of the steel sheet may be deteriorated when the content of the base resin exceeds 60 parts by weight. Therefore, the base resin may be used in the content range, and preferably in a content range of 45 to 55 parts by weight.

The inorganic component according to one exemplary embodiment of the present invention is a component that gives corrosion resistance to a steel sheet. Therefore, metal sols such as alumina sol, silica sol, titania sol and zirconia sol may be used alone or in combinations thereof. The inorganic component preferably has a particle size of 5 to 30 nm (nanometers). When the particle size of the inorganic component is less than 5 nm, the water resistance of the steel sheet may be deteriorated. On the contrary, when the particle size of the inorganic component exceeds 30 nm, the coating composition for surface-treating a steel sheet is used at a low coating amount, and therefore pores may be formed between the metal sols to cause defects in a surface of a coating film, which lead to the deteriorated corrosion resistance of the steel sheet.

The inorganic component may be used at a content of 20 to 40 parts by weight, based on the total solid content of the coating composition for surface-treating a steel sheet. When the solid content of the inorganic component is less than 20 parts by weight, based on the total content of the coating composition for surface-treating a steel sheet, the corrosion resistance of the steel sheet may be deteriorated, whereas, when the solid content of the inorganic component exceeds 40 parts by weight, the corrosion resistance of the steel sheet is improved, but it is difficult to obtain a film coated at a uniform thickness on a surface of the steel sheet, and the adhesion to the steel sheet may be deteriorated. Therefore, the inorganic component may be preferably used in the above-mentioned content range, and more preferably in a range of 25 to 35 parts by weight.

In addition, an alkoxy silane compound is added to the base resin, and thus the base resin and the inorganic metallic sol react through the medium of the alkoxy silane compound to form an organic/inorganic composite resin. Preferably, the alkoxy silane compound includes an epoxysilane compound, an aminosilane compound, etc. Specific examples of the alkoxy silane compound include, but are not particularly limited to, epoxysilane such as 2-(3,4-epoxycyclohexyl)ethyltrimethoxysilane, (3-glycidoxypropyl)trimethoxysilane, 3-glycidoxypropylmethyldiethoxysilane and 3-glycidoxypropyltriethoxysilane, and aminosilane such as N-2(aminoethyl)-3-aminopropylmethyldimethoxysilane, 3-aminopropyltrimethoxysilane, 3-aminopropyltriethoxysilane, 3-triethoxysilyl-N-(1,3-dimethyl-butylidene)propyl amine, N-phenyl-3-aminopropyltrimethoxysilane and N-(vinylbenzyl)-2-aminoethyl-3-aminopropyltrimethoxysilane hydrochloride. Each of these alkoxy silane compounds has 2 kinds of functional groups. Here, the functional group such as methoxy and ethoxy may react with metal and silica particles to form chemical bonds, and the functional group such as epoxy and amino may react with various kinds of resins to form chemical bonds. Therefore, the base resin such as the water-soluble or water-borne organic resin and the inorganic metallic sol react respectively with both functional groups of the alkoxy silane compound to form an organic/inorganic composite resin.

In this case, the alkoxy silane compound is preferably used at a content of 1 to 10 parts by weight, based on 100 parts by weight of the sum of the base resin such as water-soluble or water-borne organic resin and the inorganic metal sol component.

The carbon nanotube according to one exemplary embodiment of the present invention is to give conductivity to a steel sheet. Here, the carbon nanotube is a nano-material that has higher length/diameter ratios than conventional conductive carbon blacks, and has a very small diameter of a nanometer level. Therefore, although the carbon nanotube may be used at a small content, it gives very excellent electrical properties to the steel sheet. Accordingly, the carbon nanotube has been increasingly used in the field of anti-static or electromagnetic shielding applications.

The coating composition for surface-treating a steel sheet according to one exemplary embodiment of the present invention includes a carbon nanotube paste. Here, the carbon nanotube paste is prepared by distributing the carbon nanotube in a resin selected from the group consisting of a water-dispersible urethane resin; a copolymer such as poly(p-phenylenevinylene) (PPV), poly(p-phenylenevinylene-co-2,5-dioctoxy-m-phenylenevinylene) (PMPV) and polyaryleneethylene; a water-soluble polymer such as poly(vinylalcohol), poly(ethyleneoxide) and polysaccharide; and a surfactant such as sodium didecyl sulfate, lithium dodecyl sulfate and cetyltrimethylammonium chloride. The carbon nanotube paste may be prepared using the conventional methods, but the present invention is not particularly limited thereto.

The carbon nanotube paste is preferably used in a content range of 2 to 5 parts by weight, based on the total solid content of the coating composition for surface-treating a steel sheet according to one exemplary embodiment of the present invention. When the carbon nanotube paste is used at a solid content of less than 2 parts by weight, it is difficult for a steel sheet to secure the conductivity even when the coating composition is used at a coating amount of 1000 mg/m² or more. On the contrary, when the solid content of the carbon nanotube paste exceeds 5 parts by weight, the conductivity of the steel sheet is improved, but colors of the steel sheet coated with the coating composition for surface-treating a steel sheet according to one exemplary embodiment of the present invention may be undesirably darkened, and the surface roughness of the steel sheet may be poor.

In order to improve the corrosion resistance of the steel sheet, the coating composition for surface-treating a steel sheet according to one exemplary embodiment of the present invention includes a phosphate-based anti-corrosion agent of metal oxides, such as a phosphate solution of aluminum, aluminum diphosphate, zinc, molybdenum, fluorine and the like and an aqueous phosphate solution of hexaammonium hepta-molybdate tetrahydrate, or a anti-corrosion agent prepared by solubilizing metal such as vanadium, zirconium, titanium, molybdenum, tungsten, manganese, cerium and mixtures thereof.

The anti-corrosion agent may be added at a content of 2 to 5 parts by weight, based on the solid weight of the coating composition for surface-treating a steel sheet according to one exemplary embodiment of the present invention. When the content of the added anti-corrosion agent is less than 2 parts by weight, the corrosion resistance of the steel sheet may be insufficiently improved, whereas the corrosion resistance of the steel sheet is not improved, and storage stability of the coating composition may also be poor when the content of the added anti-corrosion agent exceeds 5 parts by weight.

For the coating composition for surface-treating a steel sheet according to one exemplary embodiment of the present invention, an organic metal complex is used to improve corrosion resistance of the steel sheet and close adhesion to the steel sheet. The organic metal complex is subject to a coupling reaction with a galvanized steel sheet so as to improve the close adhesion of the galvanized steel sheet to the coating composition for surface-treating a steel sheet, thereby enhancing the corrosion resistance of the steel sheet.

The organic metal complex may be added at a content of 5 to 15 parts by weight, based on the solid weight of the coating composition for surface-treating a steel sheet according to one exemplary embodiment of the present invention. When the content of the added organic metal complex is less than 5 parts by weight, the close adhesion to the galvanized steel sheet may be insufficiently improved, whereas, when the content of the added organic metal complex exceeds 15 parts by weight, the corrosion resistance of the steel sheet and the close adhesion to the steel sheet may be slightly improved but uneconomical, and the stability of the composition may be severely deteriorated.

The organic metal complex, which may be used in the present invention, includes a silane-based coupling agent, a titanium-based coupling agent and a zirconium-based coupling agent, and they may be used alone or in combinations thereof.

The silane-based complex includes vinyl triethoxy silane, 2-glycyloxy propyl trimethoxysilane, 3-glycyloxy propyl methyl dimethoxysilane, N-2-(aminoethyl)-3-aminopropyl triethoxy silane, 4-aminopropyl triethoxy silane, etc. And, the titanium-based coupling agent includes titanium acetylacetone, iso-butoxy titanium ethyl acetoacetate, tetraisopropyl titanate, tetra-N-butyl titanate, etc. Also, the zirconium-based coupling agent includes tetra-N-propyl zirconate, tetra N-butyl zirconate, triethanolamine zirconate, etc.

The coating composition for surface-treating a steel sheet according to one exemplary embodiment of the present invention includes 3 to 7 parts by weight of a crosslinking agent, based on the total solid weight of the composition. In this case, carbodiimide may be used as the crosslinking agent, and functions to improve the corrosion resistance of the steel sheet since it is used as the crosslinking agent of the base resin. When the carbodiimide in the coating composition for surface-treating a steel sheet according to one exemplary embodiment of the present invention is used at a content of less than 3 parts by weight, it does not show its performances as the crosslinking agent. On the contrary, when the carbodimide in the coating composition exceeds 7 parts by weight, the corrosion resistance of the steel sheet may be rather deteriorated due to the presence of non-reacted carbodiimide, and its use is uneconomical due to its high price.

The coating composition for surface-treating a steel sheet according to one exemplary embodiment of the present invention includes the above-mentioned components dissolved in water and an alcohol solvent such as ethanol. In this case, the solvent may be included in the resin composition so that the total solid content can be in a range of 5 to 25% by weight, based on the total weight of the resin composition. When the content of the solvent is out of the solid content range, a coating composition may not be used herein due to its gelation.

In addition to the above-mentioned components, the coating composition for surface-treating a steel sheet, which has excellent conductivity, according to one exemplary embodiment of the present invention may further include additives such as an inorganic solvent, antifoaming agent, a smoothness-enhancing additive, etc. Here, the additives may be used at a small amount.

A surface-treated steel sheet having excellent electric conductivity may be obtained by treating a galvanized steel sheet with the coating composition for surface-treating a steel sheet including carbon nanotube according to one exemplary embodiment of the present invention. The surface-treated steel sheet according to one exemplary embodiment of the present invention may be prepared by treating a steel sheet with the coating composition according to one exemplary embodiment of the present invention by using the conventional methods, for example, a roll-coating method and so on, but the present invention is not particularly limited thereto.

After the coating process, the surface-treated steel sheet may be dried at a peak metal temperature (PMT) of 100 to 130° C. (degrees Celsius).

After the steel sheet is coated with the coating composition for surface-treating a steel sheet, which has excellent conductivity, according to one exemplary embodiment of the present invention, the coating composition may be dried at a low temperature including the temperature range, and therefore the steel sheet has excellent physical properties even after a low-temperature curing process.

For the surface-treated steel sheet according to one exemplary embodiment of the present invention, a coating amount of a carbon nanotube-containing surface-treated thin film is preferably in a range of 600 to 2000 mg/m². When the coating amount of the surface-treated thin film is less than 600 mg/m2, corrosion resistance and scratch resistance of the steel sheet may be relatively poor, whereas when the coating amount of the surface-treated thin film exceeds 2000 mg/m², the corrosion resistance of the steel sheet is excellent, but electrical properties of the steel sheet may be deteriorated. The surface-treated steel sheet according to one exemplary embodiment of the present invention desirably has a surface resistance of 10⁻³Ω(ohm), which is set to the standard requirements of home electronics manufacturers.

Generally, when the coating amount of the surface-treated thin film exceeds 1000 mg/m², the corrosion resistance of the steel sheet is excellent, but it is difficult to secure the electric conductivity of the steel sheet. Also, when the roughness of the steel sheet is severely poor, a non-coated surface of the steel sheet may be easily exposed to the corrosion environments, and therefore the conductivity is excellent, but the corrosion resistance of the steel sheet is severely deteriorated, which makes it difficult to satisfy the requirements of electric conductivity and corrosion resistance at the same time. However, the coating composition for surface-treating a steel sheet including carbon nanotube according to one exemplary embodiment of the present invention may be used to obtain a surface-treated steel sheet whose corrosion resistance and conductivity are excellent, even when the coating composition is used at a coating amount of 1000 mg/m² or more, regardless of the surface roughness of the steel sheet.

As described above, the coating composition for surface-treating a steel sheet according to one exemplary embodiment of the present invention has characteristics that it is chrome-free and environment-friendly, and is not harmful to human bodies. Also when a steel sheet is treated with the coating composition for surface-treating a steel sheet according to one exemplary embodiment of the present invention, the steel sheet may secure its excellent corrosion resistance and electric conductivity regardless of the surface roughness of the steel sheet, and be dried and cured at a low PMT of 100 to 130° C. (degrees Celsius).

### MODE FOR THE INVENTION

Hereinafter, the exemplary embodiments of the present invention are described in more detail. In this specification, the term “percentage (%)” used in the exemplary embodiments represents ‘% by weight,’ unless indicated otherwise.

The galvanized steel sheets, which was treated with each of coating composition for surface-treating a steel sheets prepared in the following Examples and Comparative examples, were measured for appearance, adhesion, corrosion resistance at processed portion, workability after finish coating, in-plane corrosion and electric conductivity.

(1) Evaluation of Appearance

The appearance of a steel sheet was evaluated by observing stains or peeling-off with the naked eye.

(2) Adhesion

A steel sheet was cross-cut at a size of 100/100, and a taping test on the steel sheet was performed using a cellophane adhesive tape.

(3) Corrosion Resistance at Processed Portion

A test sample of the steel sheet was subject to an Erichsen test at a flexural strength of 6 mmΦ, sprayed with salt water, and white rusts on the steel sheet were observed for 48 hours after the spraying process.

(4) Workability after Finish Coating

A steel sheet was painted with a paint for home electronic appliances, and subjected to an impact test at 1000 g×30 cm. Then, a thin film formed on the steel sheet was observed.

(5) In-Plane Corrosion

A steel sheet was sprayed with a 5% saline solution at 35° C. for 72 hours, and white rusts formed on the steel sheet were observed.

(6) Electric Conductivity

The surface resistance of a steel sheet was measured using an electric resistance tester equipped with a four-line probe.

### Example 1

A coating composition for surface-treating a steel sheet (solid content: 20%) was prepared by dissolving the following components in a mixed solution of ethanol and water: 180 parts by weight of a water-dispersible urethane resin (solid content: 30%) having a carboxy group, 250 parts by weight of a water-soluble acrylic resin (solid content: 20%) having a carboxy group, 20 parts by weight of a carbon nanotube paste (solid content: 30%) in which carbon nanotube (solid content: 13%) is distributed in a water-dispersible urethane resin, 145 parts by weight of a silica sol (solid content: 30%) having a particle size of 20 to 30 nm, 30 parts by weight of 2-glycyloxy propyltrimethoxysilane (solid content: 72%), 8 parts by weight of an aqueous phosphate solution (solid content: 63%) of hexaammonium heptamolybdate tetrahydrate, and 15 parts by weight of carbodiimide (solid content: 40%). A steel sheet was coated with the prepared coating composition for surface-treating a steel sheet, and then dried at PMT of 120° C. to prepare a galvanized steel sheet in which a coating amount of the coating composition is 1000 mg/m².

### Example 2

A coating composition for surface-treating a steel sheet was prepared in the same manner as in Example 1, except that a content of the carbon nanotube paste was 30 parts by weight. A steel sheet was coated with the prepared coating composition for surface-treating a steel sheet, and then dried at PMT of 120° C. to prepare a galvanized steel sheet in which a coating amount of the coating composition is 1500 mg/m².

### Comparative Example 1

A coating composition for surface-treating a steel sheet was prepared in the same manner as in Example 1, except that the carbon nanotube paste was free from the composition of Example 1. A steel sheet was coated with the prepared coating composition for surface-treating a steel sheet, and then dried at PMT of 120° C. to prepare a galvanized steel sheet in which a coating amount of the coating composition is 1000 mg/m².

Each of the galvanized steel sheets prepared in Examples 1 and 2 and Comparative example 1 was evaluated for appearance, adhesion, corrosion resistance at processed portion, workability after finish coating, in-plane corrosion and electric conductivity, respectively. The evaluation results are listed in the following Table 1.

TABLE 1

| | | | Comparative |
|---|---|---|---|
| | Example 1 | Example 2 | example 1 |
| Appearance | ⊚ | ⊚ | ⊚ |
| Adhesion | ⊚ | ⊚ | ⊚ |
| Corrosion resistance at | ◯ | ◯ | ◯ |
| processed portion | | | |
| Workability after finish | ⊚ | ⊚ | ⊚ |
| coating | | | |
| In-plane corrosion resistance | ⊚ | ⊚ | ⊚ |
| Electric conductivity | 10⁻⁵ Ω/cm² | 10⁻⁴ Ω/cm² | 10⁷ Ω/cm² |

⊚: Most excellent, ◯: Excellent

As seen from Table 1, it was revealed that all the surface-treated steel sheets prepared in Examples 1 and 2 and Comparative example 1 have excellent properties such as appearance, adhesion, corrosion resistance at processed portion, workability after finish coating and in-plane corrosion. However, it was revealed that the surface-treated steel sheet prepared in Comparative example 1 has high surface resistance with electric conductivity of 10⁶Ω(ohm) or more, but the surface-treated steel sheets of Examples 1 and 2 using the surface-treating agent including carbon nanotube show their low surface resistance with electric conductivity of 10⁻³Ω or less, and therefore the surface-treated steel sheets of Examples 1 and 2 have highly excellent electric conductivity even when the coating composition is used at a coating amount of 1000 mg/m² or more.

### Example 3

A coating composition for surface-treating a steel sheet (total solid content: 20% by weight) was prepared by dissolving the following components in a mixed solution of ethanol and water: 320 parts by weight of a polyethylene-co-acrylic acid resin (solid content: 30%) having a weight average molecular weight of 25,000, 20 parts by weight of a carbon nanotube paste (solid content: 30%) in which carbon nanotube (solid content: 13%) is distributed in a water-dispersible urethane resin, 124 parts by weight of a silica sol (solid content: 30%) having a particle size of 20 to 30 nm, 30 parts by weight of 2-glycyloxy propyltrimethoxysilane (solid content: 72%), 12 parts by weight of an aqueous phosphate solution (solid content: 63%) of hexaammonium hepta-molybdate tetrahydrate, and 25 parts by weight of carbodiimide (solid content: 40%). A steel sheet was coated with the prepared coating composition for surface-treating a steel sheet, and then dried at PMT of 120° C. to prepare a galvanized steel sheet in which a coating amount of the coating composition is 1000 mg/m².

### Example 4

A coating composition for surface-treating a steel sheet (total solid content: 20% by weight) was prepared by dissolving the following components in a mixed solution of ethanol and water: 320 parts by weight of a water-soluble phenoxy resin (solid content: 30%) having a weight average molecular weight of 50,000, 20 parts by weight of a carbon nanotube paste (solid content: 30%) in which carbon nanotube (solid content: 13%) is distributed in a water-dispersible urethane resin, 124 parts by weight of a silica sol (solid content: 30%) having a particle size of 20 to 30 nm, 30 parts by weight of 2-glycyloxy propyltrimethoxysilane (solid content: 72%), 12 parts by weight of an aqueous phosphate solution (solid content: 63%) of hexaammonium heptamolybdate tetrahydrate, and 25 parts by weight of carbodiimide (solid content: 40%). A steel sheet was coated with the prepared coating composition for surface-treating a steel sheet, and then dried at PMT of 120° C. to prepare a galvanized steel sheet in which a coating amount of the coating composition is 1000 mg/m².

### Example 5

A coating composition for surface-treating a steel sheet was prepared in the same manner as in Example 3, except that the carbon nanotube paste was used at a content of 30 parts by weight. A steel sheet was coated with the prepared coating composition for surface-treating a steel sheet, and then dried at PMT of 120° C. to prepare a galvanized steel sheet in which a coating amount of the coating composition is 1500 mg/m².

### Example 6

A coating composition for surface-treating a steel sheet was prepared in the same manner as in Example 4, except that the carbon nanotube paste was used at a content of 30 parts by weight. A steel sheet was coated with the prepared coating composition for surface-treating a steel sheet, and then dried at PMT of 120° C. to prepare a galvanized steel sheet in which a coating amount of the coating composition is 1500 mg/m².

### Comparative Example 2

A coating composition for surface-treating a steel sheet was prepared in the same manner as in Example 3, except that the carbon nanotube paste was free from the composition of Example 3. A steel sheet was coated with the prepared coating composition for surface-treating a steel sheet, and then dried at PMT of 120° C. to prepare a galvanized steel sheet in which a coating amount of the coating composition is 1000 mg/m².

### Comparative Example 3

A coating composition for surface-treating a steel sheet was prepared in the same manner as in Example 4, except that the carbon nanotube paste was free from the composition of Example 4. A steel sheet was coated with the prepared coating composition for surface-treating a steel sheet, and then dried at PMT of 120° C. to prepare a galvanized steel sheet in which a coating amount of the coating composition is 1000 mg/m².

Each of the galvanized steel sheets prepared in Examples 3 to 6 and Comparative examples 2 and 3 was evaluated for appearance, adhesion, corrosion resistance at processed portion, workability after finish coating, in-plane corrosion and electric conductivity, respectively. The evaluation results are listed in the following Table 2.

TABLE 2

| | | | | | Comparative | Comparative |
|---|---|---|---|---|---|---|
| | Example 3 | Example 4 | Example 5 | Example 6 | example 2 | example 3 |
| Appearance | ⊚ | ⊚ | ⊚ | ⊚ | ⊚ | ⊚ |
| Adhesion | ⊚ | ⊚ | ⊚ | ⊚ | ⊚ | ⊚ |
| Corrosion resistance | ◯ | ⊚ | ◯ | ◯ | ◯ | ◯ |
| at | | | | | | |
| processed portion | | | | | | |
| Workability after | ⊚ | ⊚ | ⊚ | ⊚ | ⊚ | ⊚ |
| finish coating | | | | | | |
| In-plane corrosion | ◯ | ◯ | ⊚ | ⊚ | ◯ | ◯ |
| resistance | | | | | | |
| Electric conductivity | 10⁻⁵ Ω/cm² | 10⁻⁵ Ω/cm² | 10⁻⁴ Ω/cm² | 10⁻⁴ Ω/cm² | 10⁷ Ω/cm² | 10⁸ Ω/cm² |

⊚: Most excellent,
◯: Excellent

As seen from Table 2, it was revealed that all the surface-treated steel sheets prepared in Examples 3 to 6 and Comparative examples 2 and 3 have excellent properties such as appearance, adhesion, corrosion resistance at processed portion, workability after finish coating and in-plane corrosion. However, it was revealed that the surface-treated steel sheet prepared in Comparative examples 2 and 3 have high surface resistance with electric conductivity of 10⁶Ω or more, but the surface-treated steel sheets of Examples 3 to 6 using the surface-treating agent including carbon nanotube show their low surface resistance with electric conductivity of 10⁻³Ω or less, and therefore the surface-treated steel sheets of Examples 3 to 6 have highly excellent electric conductivity even when the coating composition is used at a coating amount of 1000 mg/m² or more.

### Example 7

A coating composition for surface-treating a steel sheet (total solid content: 20% by weight) was prepared by dissolving the following components in a mixed solution of ethanol and water: 180 parts by weight of a water-dispersible urethane resin (solid content: 30%) having a carboxy group, 250 parts by weight of a water-soluble acrylic resin (solid content: 20%) having a carboxy group, 20 parts by weight of a carbon nanotube paste (solid content: 30%) in which carbon nanotube (solid content: 13%) is distributed in a poly(p-phenylene vinylene) resin, 145 parts by weight of a silica sol (solid content: 30%) having a particle size of 20 to 30 nm, 30 parts by weight of 2-glycyloxy propyltrimethoxysilane (solid content: 72%), 8 parts by weight of an aqueous phosphate solution (solid content: 63%) of hexaammonium heptamolybdate tetrahydrate, and 15 parts by weight of carbodiimide (solid content: 40%). A steel sheet was coated with the prepared coating composition for surface-treating a steel sheet, and then dried at PMT of 120° C. to prepare a galvanized steel sheet in which a coating amount of the coating composition is 1000 mg/m².

### Example 8

A coating composition for surface-treating a steel sheet (total solid content: 20% by weight) was prepared by dissolving the following components in a mixed solution of ethanol and water: 180 parts by weight of a water-dispersible urethane resin (solid content: 30%) having a carboxy group, 250 parts by weight of a water-soluble acrylic resin (solid content: 20%) having a carboxy group, 20 parts by weight of a carbon nanotube paste (solid content: 30%) in which carbon nanotube (solid content: 13%) is distributed in a poly(vinylalcohol) resin, 145 parts by weight of a silica sol (solid content: 30%) having a particle size of 20 to 30 nm, 30 parts by weight of 2-glycyloxy propyltrimethoxysilane (solid content: 72%), 8 parts by weight of an aqueous phosphate solution (solid content: 63%) of hexaammonium heptamolybdate tetrahydrate, and 15 parts by weight of carbodiimide (solid content: 40%). A steel sheet was coated with the prepared coating composition for surface-treating a steel sheet, and then dried at PMT of 120° C. to prepare a galvanized steel sheet in which a coating amount of the coating composition is 1000 mg/m².

### Example 9

A coating composition for surface-treating a steel sheet was prepared in the same manner as in Example 7, except that the carbon nanotube paste was used at a content of 30 parts by weight. A steel sheet was coated with the prepared coating composition for surface-treating a steel sheet, and then dried at PMT of 120° C. to prepare a galvanized steel sheet in which a coating amount of the coating composition is 1500 mg/m².

### Example 10

A coating composition for surface-treating a steel sheet was prepared in the same manner as in Example 8, except that the carbon nanotube paste was used at a content of 30 parts by weight. A steel sheet was coated with the prepared coating composition for surface-treating a steel sheet, and then dried at PMT of 120° C. to prepare a galvanized steel sheet in which a coating amount of the coating composition is 1500 mg/m².

### Comparative Example 4

A coating composition for surface-treating a steel sheet was prepared in the same manner as in Example 7, except that the carbon nanotube paste was free from the composition of Example 7. A steel sheet was coated with the prepared coating composition for surface-treating a steel sheet, and then dried at PMT of 120° C. to prepare a galvanized steel sheet in which a coating amount of the coating composition is 1000 mg/m².

Each of the galvanized steel sheets prepared in Examples 7 to 10 and Comparative example 4 was evaluated for appearance, adhesion, corrosion resistance at processed portion, workability after finish coating, in-plane corrosion and electric conductivity, respectively. The evaluation results are listed in the following Table 3.

TABLE 3

| | | | | Example | Comparative |
|---|---|---|---|---|---|
| | Example 7 | Example 8 | Example 9 | 10 | example 4 |
| Appearance | ⊚ | ⊚ | ⊚ | ⊚ | ⊚ |
| Adhesion | ⊚ | ⊚ | ⊚ | ⊚ | ⊚ |
| Corrosion resistance at | ◯ | ⊚ | ◯ | ◯ | ◯ |
| processed portion | | | | | |
| Workability after | ⊚ | ⊚ | ⊚ | ⊚ | ⊚ |
| finish coating | | | | | |
| In-plane corrosion resistance | ◯ | ◯ | ⊚ | ⊚ | ◯ |
| Electric conductivity | 10⁻⁵ Ω/cm² | 10⁻⁵ Ω/cm² | 10⁻⁴ Ω/cm² | 10⁻⁴ Ω/cm² | 10⁷ Ω/cm² |

⊚: Most excellent,
◯: Excellent

As seen from Table 3, it was revealed that all the surface-treated steel sheets prepared in Examples 7 to 10 and Comparative example 1 have excellent properties such as appearance, adhesion, corrosion resistance at processed portion, workability after finish coating and in-plane corrosion. However, it was revealed that the surface-treated steel sheet prepared in Comparative example 4 has high surface resistance with electric conductivity of 10⁶Ω or more, but the surface-treated steel sheets of Examples 7 to 10 using the surface-treating agent including carbon nanotube show their low surface resistance with electric conductivity of 10⁻³Ω or less, and therefore the surface-treated steel sheets of Examples 7 to 10 have highly excellent electric conductivity even when the coating composition is used at a coating amount of 1000 mg/m² or more.

### Example 11

A coating composition for surface-treating a steel sheet (total solid content: 20% by weight) was prepared by dissolving the following components in a mixed solution of ethanol and water: 180 parts by weight of a water-dispersible urethane resin (solid content: 30%) having a carboxy group, 250 parts by weight of a water-soluble acrylic resin (solid content: 20%) having a carboxy group, 20 parts by weight of a carbon nanotube paste (solid content: 30%) in which carbon nanotube (solid content: 13%) is distributed in a water-dispersible urethane resin, 145 parts by weight of a silica sol (solid content: 30%) having a particle size of 20 to 30 nm, 30 parts by weight of 2-glycyloxy propyltrimethoxysilane (solid content: 72%), 8 parts by weight of an aqueous vanadium trioxide solution (solid content: 63%), and 15 parts by weight of carbodiimide (solid content: 40%). A steel sheet was coated with the prepared coating composition for surface-treating a steel sheet, and then dried at PMT of 120° C. to prepare a galvanized steel sheet in which a coating amount of the coating composition is 1000 mg/m².

### Example 12

A coating composition for surface-treating a steel sheet (total solid content: 20% by weight) was prepared by dissolving the following components in a mixed solution of ethanol and water: 180 parts by weight of a water-dispersible urethane resin (solid content: 30%) having a carboxy group, 250 parts by weight of a water-soluble acrylic resin (solid content: 20%) having a carboxy group, 20 parts by weight of a carbon nanotube paste (solid content: 30%) in which carbon nanotube (solid content: 13%) is distributed in a water-dispersible urethane resin, 145 parts by weight of a silica sol (solid content: 30%) having a particle size of 20 to 30 nm, 30 parts by weight of 2-glycyloxy propyltrimethoxysilane (solid content: 72%), 8 parts by weight of an aqueous calcium phosphosilicate solution (solid content: 63%), and 15 parts by weight of carbodiimide (solid content: 40%). A steel sheet was coated with the prepared coating composition for surface-treating a steel sheet, and then dried at PMT of 120° C. to prepare a galvanized steel sheet in which a coating amount of the coating composition is 1000 mg/m².

### Example 13

A coating composition for surface-treating a steel sheet was prepared in the same manner as in Example 11, except that the carbon nanotube paste was used at a content of 30 parts by weight. A steel sheet was coated with the prepared coating composition for surface-treating a steel sheet, and then dried at PMT of 120° C. to prepare a galvanized steel sheet in which a coating amount of the coating composition is 1500 mg/m².

### Example 14

A coating composition for surface-treating a steel sheet was prepared in the same manner as in Example 12, except that the carbon nanotube paste was used at a content of 30 parts by weight. A steel sheet was coated with the prepared coating composition for surface-treating a steel sheet, and then dried at PMT of 120° C. to prepare a galvanized steel sheet in which a coating amount of the coating composition is 1500 mg/m².

### Comparative Example 5

A coating composition for surface-treating a steel sheet was prepared in the same manner as in Example 11, except that the carbon nanotube paste was free from the composition of Example 11. A steel sheet was coated with the prepared coating composition for surface-treating a steel sheet, and then dried at PMT of 120° C. to prepare a galvanized steel sheet in which a coating amount of the coating composition is 1000 mg/m².

Each of the galvanized steel sheets prepared in Examples 11 to 14 and Comparative example 5 was evaluated for appearance, adhesion, corrosion resistance at processed portion, workability after finish coating, in-plane corrosion and electric conductivity, respectively. The evaluation results are listed in the following Table 4.

TABLE 4

| | Example | Example | Example | Example | Comparative |
|---|---|---|---|---|---|
| | 11 | 12 | 13 | 14 | example 5 |
| Appearance | ⊚ | ⊚ | ⊚ | ⊚ | ⊚ |
| Adhesion | ⊚ | ⊚ | ⊚ | ⊚ | ⊚ |
| Corrosion resistance at | ◯ | ⊚ | ◯ | ◯ | ◯ |
| processed portion | | | | | |
| Workability after finish | ⊚ | ⊚ | ⊚ | ⊚ | ⊚ |
| coating | | | | | |
| In-plane corrosion resistance | ◯ | ◯ | ⊚ | ⊚ | ◯ |
| Electric conductivity | 10⁻⁵ Ω/cm² | 10⁻⁵ Ω/cm² | 10⁻⁴ Ω/cm² | 10⁻⁴ Ω/cm² | 10⁷ Ω/cm² |

⊚: Most excellent,
◯: Excellent

As seen from Table 4, it was revealed that all the surface-treated steel sheets prepared in Examples 11 to 14 and Comparative example 5 have excellent properties such as appearance, adhesion, corrosion resistance at processed portion, workability after finish coating and in-plane corrosion. However, it was revealed that the surface-treated steel sheet prepared in Comparative example 5 has high surface resistance with electric conductivity of 10⁶Ω or more, but the surface-treated steel sheets of Examples 11 to 14 using the surface-treating agent including carbon nanotube show their low surface resistance with electric conductivity of 10⁻³Ω or less, and therefore the surface-treated steel sheets of Examples 11 to 14 have highly excellent electric conductivity even when the coating composition is used at a coating amount of 1000 mg/m² or more.

As described above, it was revealed that, when a steel sheet was coated with a metal coating paint including the chrome-free coating composition for a hot-dip galvanized steel sheet including carbon nanotube having excellent electric conductivity, and then dried with heat, the resultant galvanized steel sheet has excellent electric conductivity, as well as the excellent corrosion resistance even when the coating composition is used at a coating amount of 1000 mg/m² or more. Also, the chrome-free coating composition for surface-treating a steel sheet according to one exemplary embodiment of the present invention does not include a heavy metal that is harmful to human body, and its components are dissolved in water (main component) used as a solvent. Therefore, the chrome-free coating composition according to one exemplary embodiment of the present invention may be useful to relieve an energy-saving problem, environmental pollutions, operational hygienic/stability problems and fire risks.

1. A chrome-free coating composition for surface-treating a hot-dip galvanized steel sheet having excellent electric conductivity, comprising, based on the total solid weight of the composition:
(a) 40 to 60 parts by weight of a water-soluble or water-borne organic resin as a base resin;
(b) 20 to 40 parts by weight of an inorganic metallic sol;
(c) 2 to 5 parts by weight of a carbon nanotube paste including carbon nanotube (CNT);
(d) 2 to 5 parts by weight of a metal oxide/phosphate-based anti-corrosion agent;
(e) 5 to 15 parts by weight of an organic metal complex; and
(f) 3 to 7 parts by weight of a cross-linking agent.

2. The chronic-free coating composition of claim 1, comprising water or alcohol as a solvent so that the total solid content in the composition is in a range of 5 to 25% by weight.

3. The chrome-free coating composition of claim 1, wherein the water-soluble organic resin is selected from the group consisting of a water-dispersible urethane resin having a carboxy or hydroxyl group, an acrylic resin having a carboxy or hydroxyl group, an acryl or vinyl-modified water-dispersible urethane resin, an olefin resin such as poly(ethylene-co-acrylic acid) and poly (ethylene-co-methacrylic acid), a phenoxy resin including bisphenol A, and mixtures thereof.

4. The chrome-free coating composition of claim 1, wherein the inorganic metallic sol is selected from the group consisting of a silica sol, an alumina sol, a titania sol, a zirconia sol and mixtures thereof.

5. The chrome-free coating composition of claim 1, wherein the inorganic metallic sol has a metal particle size of 5 to 30 nm.

6. The chrome-free coating composition of claim 1, wherein the carbon nanotube paste is prepared by dispersing carbon nanotube in a resin selected from the group consisting of a water-dispersible urethane resin; a copolymer such as poly(p-phenylenevinylene) (PPV), poly(p-phenylenevinylene-co-2,5-dioctoxy-m-phenylenevinylene) (PMPV) and polyaryleneethylene; a water-soluble polymer such as poly(vinylalcohol), poly(ethyleneoxide) and polysaccharide; and a surfactant such as sodium dodecyl sulfate, lithium dodecyl sulfate and cetyltrimethylammonium chloride.

7. The chrome-free coating composition of claim 1, wherein the corrosion resistance rust inhibitor is an aqueous solution including one selected from the group consisting of vanadium, zirconium, titanium, molybdenum, tungsten, manganese, cerium and mixtures thereof, or an aqueous phosphate solution of phosphate or hexaammonium heptamolybdate tetrahydrate including one selected from the group consisting of aluminum, aluminum diphosphate, zinc, molybdenum, fluorine and mixtures thereof.

8. The chrome-free coating composition of claim 1, wherein the organic metal complex is selected from the group consisting of a silane-based coupling agent, a titanium-based coupling agent, a zirconium-based coupling agent and mixtures thereof.

9. The chrome-free coating composition of claim 1, wherein the cross-linking agent is carbodimide cross-linking agent.

10. The chrome-free coating composition of claim 1, further comprising an alkoxy silane compound, wherein an organic/inorganic composite resin is formed by reaction of the water-soluble organic resin and inorganic metallic sol and the alkoxy silane compound.

11. The chrome-free coating composition of claim 10, wherein the alkoxy silane compound is present at a content of 1 to 10 parts by weight, based on 100 parts by weight of the sum of the solid weights of the water-soluble organic resin and the inorganic metal sol.

12. The chrome-free coating composition of claim 10, wherein the alkoxy silane compound comprises epoxysilane such as (3-glycidoxypropyl)trimethoxysilane, 2-(3,4-epoxycyclohexyl)ethyltrimethoxysilane, 3-glycidoxypropylmethyldiethoxysilane and 3-glycidoxypropyltriethoxysilane, or aminosilane such as N-2(aminoethyl)-3-aminopropylmethyldimethoxysilane, 3-aminopropyltrimethoxysilane, 3-aminopropyltriethoxysilane, 3-triethoxysilyl-N-(1,3-dimethyl-butylidene)propyl amine, N-phenyl-3-aminopropyltrimethoxysilane and N-(vinylbenzyl)-2-aminoethyl-3-aminopropyltrimethoxysilane hydrochloride.

13. A surface-treated steel sheet having excellent electric conductivity, comprising a hot-dip galvanized layer and a surface-treated layer, wherein the surface-treated layer is formed from the coating composition for surface-treating a steel sheet defined in claim 1, and a coating amount of the surface-treated layer is in a range of 600 to 2000 mg/m².

14. A surface-treated steel sheet having excellent electric conductivity, comprising a hot-dip galvanized layer and a surface-treated layer, wherein the surface-treated layer is formed from the coating composition for surface-treating a steel sheet defined in claim 10, and a coating amount of the surface-treated layer is in a range of 600 to 2000 mg/m².

15. The chrome-free coating composition of claim 2, further comprising an alkoxy silane compound, wherein an organic/inorganic composite resin is formed by reaction of the water-soluble organic resin and inorganic metallic sol and the alkoxy silane compound.

16. The chrome-free coating composition of claim 3, further comprising an alkoxy silane compound, wherein an organic/inorganic composite resin is formed by reaction of the water-soluble organic resin and inorganic metallic sol and the alkoxy silane compound.

17. The chrome-free coating composition of claim 4, further comprising an alkoxy silane compound, wherein an organic/inorganic composite resin is formed by reaction of the water-soluble organic resin and inorganic metallic sol and the alkoxy silane compound.

18. The chrome-free coating composition of claim 6, further comprising an alkoxy silane compound, wherein an organic/inorganic composite resin is formed by reaction of the water-soluble organic resin and inorganic metallic sol and the alkoxy silane compound.

19. The chrome-free coating composition of claim 7, further comprising an alkoxy silane compound, wherein an organic/inorganic composite resin is formed by reaction of the water-soluble organic resin and inorganic metallic sol and the alkoxy silane compound.

20. The chrome-free coating composition of claim 8, further comprising an alkoxy silane compound, wherein an organic/inorganic composite resin is formed by reaction of the water-soluble organic resin and inorganic metallic sol and the alkoxy silane compound.
